(19) United States
(12) Patent Application Publication
(10) Pub. No.: US 2008/0071807 A1
(43) Pub. Date: Mar. 20, 2008

(54) METHODS AND SYSTEMS FOR ENTERPRISE PERFORMANCE MANAGEMENT

(76) Inventors: Nagaraju Pappu, Bangalore (IN); Satish Sukumar, Bangalore (IN)

Correspondence Address: SCHNECK & SCHNECK, P.O. BOX 2-E, SAN JOSE, CA, 95109-0005, US

(21) Appl. No.: 11/687,490

(22) Filed: Mar. 16, 2007

(30) Foreign Application Priority Data
Mar. 17, 2006 (IN) 485/CHE/2006

(51) Int. Cl. G06F 7/00

(52) U.S. Cl. 707/100

(57) ABSTRACT

A method and system for managing performance of an enterprise is provided. The method includes, defining one or more performance characteristics of the enterprise corresponding to one or more dimensions of the enterprise. The method further includes, identifying one or more objects of the enterprise based on a topology of the enterprise. One or more objects are identified corresponding to one or more dimensions. An object is one of an infrastructure object and a non-infrastructure object. Thereafter, one or more objects of the enterprise are represented on a predefined semantic network. The method further includes, determining one or more performance characteristics of the enterprise based on the representation of the one or more objects on the predefined semantic network.

### TECHNICAL FIELD

The invention generally relates to an enterprise More specifically, the invention relates to Enterprise Performance Management (EPM) Business process management.

### BACKGROUND OF THE INVENTION

The invention generally relates to an enterprise. More specifically, the invention relates to Enterprise Performance Management (EPM)/Business process management.

An EPM tool provides measurement and analytical data for an enterprise. The measurement and analytical data are used to determine information on the performance of the enterprise. An EPM tool generally provides a plurality of features. The plurality of features include, but are not limited to, resource planning, capacity planning, business scorecards, and business performance metrics.

Conventional EPM tools integrate with software/hardware applications, and computing infrastructure used in the enterprise. The software/hardware applications and computing infrastructure are monitored by the conventional EPM tools to retrieve data, which is then correlated to measure the performance of the enterprise from a business perspective.

Further, the conventional EPM tools analyze the performance of enterprise only by viewing software/hardware applications and infrastructure used in the enterprise. They provide information that is limited in context. Moreover, the impact of this information on the overall performance of the enterprise is not analyzed. Additionally, a consistent engineering definition of performance of the enterprise is not provided. The conventional EPM tools calculate the performance of the enterprise from the perspective of software applications and IT-infrastructure. Therefore, the conventional EPM tools require expensive re-implementation and upgrades if the enterprise evolves.

There is therefore a need for a system in which performance definitions for the enterprise can be clearly defined. Further, the system should support abstraction of the enterprise. Moreover, the system should be able to interpret interactions between objects of the enterprise and relationships between the objects.

### SUMMARY

An object of the invention is to provide a method and system that considerably reduces the time and cost of implementing a powerful, scalable, and flexible EPM solution by an enterprise.

Another object of the invention is to provide a method and system to model a conceptual structure of the enterprise. The conceptual structure is used to define EPM for the enterprise.

Yet another object of the invention is to provide a method and system in which EPM for the enterprise can be modeled for multi-function, multi-process, multi-structured modern enterprise.

Another object of the invention is to provide a method and system in which EPM solution for the enterprise can be easily expanded if the enterprise evolves.

Yet another object of the invention is to provide a method and system in which an object can be represented as a resource or an asset such that determination of EPM of the enterprise becomes straightforward and simple.

Another object of the invention is to provide a method and system in which a deterministic and predictable model of measuring performance of the enterprise is provided that eliminates the need for custom implementation.

Yet another object of the invention is to provide a method and system to integrate non-infrastructure resources, for example, people and processes.

Another object of the invention is to provide a method and system in which dynamic views and topologies of the enterprise can be generated from perspective of business functions.

Yet another object of the invention is to provide a method and system such that re-engineering efforts to adapt with evolving enterprise are not required.

Another object of the invention is to provide a method and system in which a dynamic event model provides real time information and measurements about critical events, activity and effect of the events on the performance, and efficiency of the enterprise.

Yet another object of the invention is to provide a method and system in which new semantic types, new relationships, and new types of events can be added flexibly through a programming interface.

The above objectives are achieved by providing methods and systems for managing performance of an enterprise. The method includes, defining one or more performance characteristics of the enterprise corresponding to one or more dimensions of the enterprise. The method further includes, identifying one or more objects of the enterprise based on a topology of the enterprise. One or more objects are identified corresponding to one or more dimensions. An object is one of an infrastructure object and a non-infrastructure object. Thereafter, one or more objects of the enterprise are represented on a predefined semantic network. The method further includes, determining one or more performance characteristics of the enterprise based on the representation of the one or more objects on the predefined semantic network.

### BRIEF DESCRIPTION OF DRAWINGS

A more complete appreciation of the present invention and the attended advantages will become readily apparent as the advantages become better understood by reference of the following detailed description when considered in conjunction with the accompanying drawings in which reference symbols indicate the same or similar components, wherein:

FIG. 1 is a flowchart of a method for managing performance of an enterprise, in accordance with an embodiment of the invention.

FIG. 2 is a flowchart of a method for managing performance of an enterprise, in accordance with an embodiment of the invention.

FIG. 3 is a flowchart of a method for representing at least one object of an enterprise on a predefined semantic network, in accordance with an embodiment of the invention.

FIG. 4 is a flowchart of a method for determining at least one performance characteristic of an enterprise, in accordance with an embodiment of the invention.

FIG. 5 is a block diagram showing various components of a system for managing performance of an enterprise, in accordance with an embodiment of the invention.

FIG. 6 is a block diagram showing various components of a representing module, in accordance with an embodiment of the invention.

FIG. 7 is a block diagram showing various components of a determining module, in accordance with an embodiment of the invention.

### DETAILED DESCRIPTION OF DRAWINGS

Various embodiments of the invention provide methods and systems for managing performance of an enterprise. The performance of the enterprise is measured by measuring the performance of objects of the enterprise taking into account their relationships with one another. Examples of the objects of the enterprise may include, but are not limited to, a server, people, router, banking transactions, and Automated Teller Machine (ATM). The methods used for managing performance of the enterprise are based on three aspects, i.e., monitoring, measurement and management.

In monitoring, observations are made on the objects of the enterprise. The observations made on the objects are then used to collect data and events for the objects. Further, the events of the objects and the data collected for them are used to determine t he activities executed by the objects.

After monitoring the objects of the enterprise, monitored data is used to make measurement on the objects. The measurements are used to define performance characteristics of the objects from the perspective of their interaction with one another. the performance characteristics of the object are defined in terms of reliability, availability, serviceability and performance. Thereafter, management is performed in the enterprise. In management, information obtained from measurement is used to support decision-making and planning activities. The activities may include, but are not limited to resource allocation, capacity planning, availability analysis and improving quality of service.

Further, activities of management are executed on the objects of the enterprise, as a result of which, design and configuration of the enterprise is changed. The change in the design and configuration of the enterprise results to a change in activities of the enterprise.

Monitoring, Measurement, and Management (MMM) work in a cycle, such that, change in the activities of the enterprise after executing the activities of management during a first MMM cycle is picked up during monitoring in a second MMM cycle. The change in the activities of the enterprise picked up by monitoring during the second MMM cycle is reflected in values obtained during measurement in the second MMM cycle. Thereafter, information obtained during measurement in the second MMM cycle is used to support decision-making and planning activities in the second MMM cycle. Therefore, a predictive-analysis of the performance of the enterprise can be performed in Real-Time (RT). This aspect enables the enterprise to execute management actions pro-actively or with minimum latency from the occurrence of an event in the enterprise. The method for managing performance of the enterprise in accordance with various embodiments of the invention is explained hereinafter.

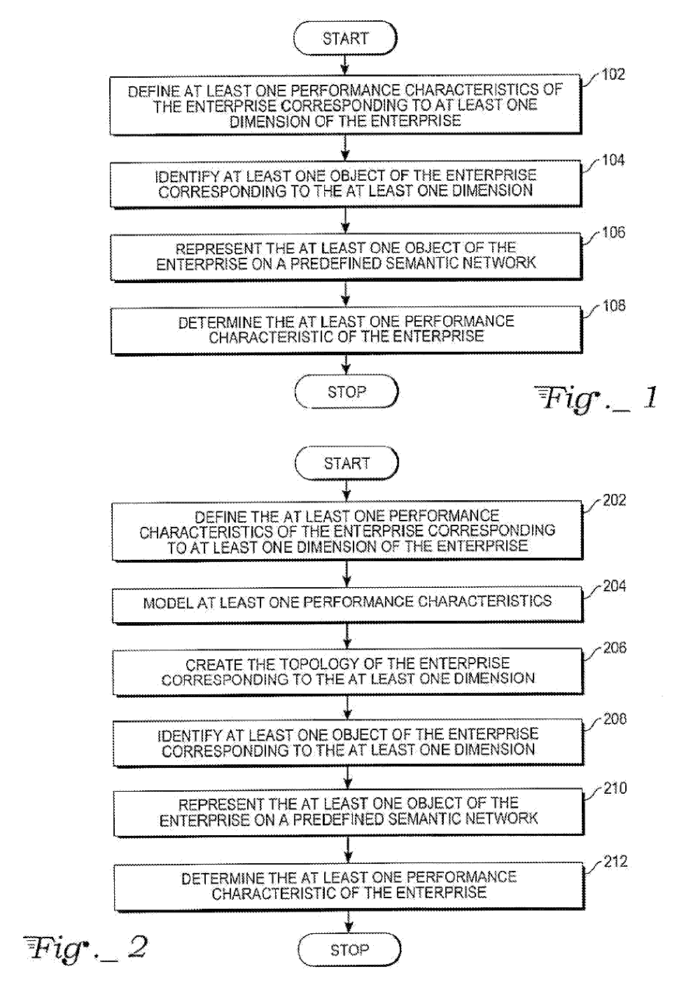

FIG. 1 is a flowchart of a method for managing performance of an enterprise, in accordance with an embodiment of the invention. At step 102, one or more performance characteristics of the enterprise are defined corresponding to one or more dimensions of the enterprise. One or more performance characteristics defined for the enterprise include Reliability, Availability, Serviceability and Performance (RASP). The performance of the enterprise is defined as a function of one or more performance characteristics of objects of the enterprise.

Further, performance characteristics of an object can be measured, if behavior of the object can be expressed in terms of RASP. Therefore, for objects, such as, business processes and business functions that implement a plurality of systems in the enterprise and are not concrete, RASP characteristics have to be defined. Further, in an embodiment of the invention, defining one or more performance characteristics of the enterprise includes modeling one or more performance characteristics. One or more performance characteristics are modeled so that they can be measured corresponding to one or more dimensions of the enterprise. A model for measuring the RASP for objects that are not concrete has to be defined. The method for modeling one or more performance characteristics of an object in accordance with various embodiments of the invention is explained hereinafter.

Reliability of an object is a measure of the consistency, and correctness of the object with respect to its behavior. Further, reliability of an object is measured by an object in terms of the correct performance of functions of the objects, the consistent state of the object, and systems/environment that use the object. For example, the object is an ATM. The reliability of the ATM is measured in terms of it consistency in dispensing the correct amount of money each time the ATM is used. As another example of reliability, the object is a banking transaction. The reliability of the banking transaction is measured by evaluating the consistency in debiting and crediting the correct amount each time. Reliability calculation of an object enables determining the reason for un-reliability of the object. Therefore, the object can be managed such that, a desired level of reliability is obtained for the object.

In an exemplary embodiment of the invention, the reliability measure of an object is represented as a histogram for each function/operation/service of the object. The total reliability of the object may be measured as the weighted average of each histogram of the object.

Availability of an object is a measure of the correctness of a state of the object to perform a service that the object is required to perform at a given time. From the perspective of availability, an object is viewed as a resource that offers a predefined set of services. Availability of an object may be measured in terms of Mean Time Between Failure (MTBF) and Maximum Time To Repair (MTTR) and is affected by faults and failures in the object. The faults and failures may be caused by one or more of internal errors in the object, and exceptional state of the object, and the exceptional state of the environment in which the object performs the predefined set of services. For example, a hard-disk crash may lead to the unavailability of the database service.

In an exemplary embodiment of the invention, availability is measured statistically and is calculated for a particular period of time. The availability of an object is expressed in percentages. In another exemplary embodiment of the invention, availability of an object for a time period is measure by using equation 1.

Availability=(MTBF*100)/(MTBF+MTTR)

Further, availability is impacted by a plurality of events, which have to be considered to measure the availability of an object. The plurality of events are grouped to form events that include errors, events that indicate exceptions, failure conditions, and resource shortfalls. In addition to the plurality of events that impact availability, a predefined set of conditions also impact availability. The predefined set of conditions include, the presence of backup, clustering and other fault tolerance techniques, occurrence of faults, and failures.

Supportability/serviceability of an object is the ability of an object to provide measurements and data for the internal behavior of the object. The measurements and the data for the internal behavior is required to measure the reliability, the availability, and the performance of the object, so that, an error in the object or an error in the functions performed by the object can be detected before they adversely effect the performance of the enterprise. Supportability/serviceability of an object may be measured as the ability of an object to react to external corrective actions executed on the object.

Performance of an object is measured as a factor of the effort expended by the object. Additionally, performance of an object is calculated as a function of response time and throughput of an investment in each resource that is used by the object. Response time of a computer intensive operation, for example, can be calculated at various values of Central Processing Unit (CPU) power. The throughput for an object is measured as the number of transactions or operations executed by the object in a time period. Performance of an object is measured in time units. The time unit used for different objects vary—for computing operations it is milliseconds, whereas for the business processes the time units are days or even months. Performance values of an object are calculated at periodic intervals.

Additionally, a defect, delay or failure in a resource used by an object or in an environment that the object works in, causes a drop in performance of the object. The drop in the performance of the object creates delay and failures in other objects, which are waiting for a resource to be released by the object or are using the object as a resource. For example, if a resource dispenser slows down, then each object that is waiting for a resource to be released from the resource dispenser come to a standstill.

Further, one or more dimensions of the enterprise, corresponding to which one or more performance characteristics of the enterprise are defined and modeled, include, a business system dimension, an Information Technology-System (IT-System) dimension, a software system dimension, and an infrastructure dimension. Each dimension of the enterprise views the enterprise form a different perspective. Therefore, one or more performance characteristics of the enterprise for each dimension of the enterprise are defined in dissimilar way.

The business system dimension views the enterprise form the perspective of business functions of the enterprise, the structure of the enterprise, and the systems employed to realize the business functions. The business system dimension includes measurements of business functions, business processes and workflow within the enterprise. Further, in the business system dimension, the enterprise is viewed as a business system described in terms of business workflows. The business system includes business process, people that run the business process, and data that is used in the business process.

Further, as the business system includes people, process, and data, therefore, RASP in the business system dimension is defined in terms of the efficiency and reliability of the business processes and business workflows. Reliability is measured in terms of the correctness of execution of each stage of a business workflow, and the correctness of processing units that execute each stage of the business workflow. Additionally, availability is defined in terms of business processes and business workflows. For example, if a business process is an order processing workflow, then the availability of the workflow is defined in terms of dependent components, people, and systems that process data used in the order processing workflow. If a single person, who is authorized to approve the order in the order processing workflow is not available, then the business process cannot be executed. Further, performance is also defined in terms of business processes and business workflows. For example, if a business process is an ordering processing workflow, then the performance of the ordering processing workflow is defined in terms of the number of orders that can be processed in a time period, and the bottlenecks in the workflow that affect the throughput and response times in execution of the ordering processing workflow. The bottlenecks include one or more of people, process or systems that work on data used in the ordering processing workflow.

Further, the IT-System dimension the enterprise form perspective of functional systems, non-functional IT-sub-systems, and communication sub-systems. For example, the functional systems in a connected Enterprise Application Integration (EAI) system include, Enterprise Resource Management (ERP), payroll systems, financial systems, accounting systems, supply chain management systems, and Human Resource (HR) systems. Additionally, the non-functional IT-sub-systems include in the connected EAI system include, application servers, databases, EAI servers, and portal servers. The non-functional IT-sub-systems are used to build the EAI system together. Further, the communication sub-systems in the EAI system include, a plurality of messaging systems and networking products.

The IT-System dimension represents the structure of the enterprise by displaying the connections between the functional systems, the non-functional IT-sub-systems, and the communication sub-systems. Therefore, RASP of the IT-System is defined base on the interactions and relationships between the functional systems, the non-functional IT-sub-systems, and the communication sub-systems.

Further, the software system dimension views the enterprise from the perspective of software applications used in the IT-system of the enterprise. For example, software applications in an ERP system may include, but are not limited to, an underlying database, main ERP servers, clients, and modules implemented on the ERP system. Similarly, software applications in a database system may include, but are not limited to, main database server applications, and tools, libraries, and database components that are installed as a part of the database system. The software applications in the software system dimension produce events and data. Further, the software applications store, retrieve, and process data and produce error logs, events, notifications and alerts.

Additionally, objects in the software system dimension, i.e., the software applications include information and have functionality and operations defined on them. Further, the objects can be monitored from perspective of RASP of the objects. Therefore, functions and operations of the objects can be defined. Thereafter, method to monitor the functions and the operations of the objects, data to be observed and analyzed for the objects and the algorithms for implementing measurement of RASP of the objects can be defined. Further, reliability, availability, and performance for the objects in the software system dimension and especially the infrastructure systems dimension are defined using industry standards. Further, measurement for the objects is derived from the published specifications for the RASP characteristics of the object.

The infrastructure dimension views the enterprise from the perspective of physical IT resources, non-IT resources, and infrastructure objects that form core infrastructural assets of the enterprise. In the infrastructure dimension, physical assets and resources are configured and managed. Additionally, the associations between the physical assets and resources is structured in the infrastructure dimension. Further, in the infrastructure dimension, physical fault tolerance, resilience aspects, for example, clusters, Redundant Array of Inexpensive Disks (RAID) arrays, primary and backup configurations, and load balancers are realized.

Further, in the infrastructure dimension, objects of the higher dimensions, i.e., business dimension, IT-system dimension, and software system dimension are viewed as resources and assets. Therefore, primary objects of the infrastructure dimension are assets and resources. An object that has an associated cost, one or more clearly outlined functions, and a clearly outlined lifetime is considered as an infrastructure object. For example, a software application may be considered as an infrastructure object. Similarly, people who perform clearly outlined functions may be considered as infrastructure objects. Additionally, for RASP measurements of objects in the infrastructure dimension, one or more of benchmarks, statistical and historical data and information of the objects are used. One or more of benchmarks, statistical and historical data and information of the objects are related to the RASP characteristics of the objects. As objects in the infrastructure dimension, excluding non-IT objects (for example, people) are manufactured to a precise engineering specification, therefore, method for measuring RASP characteristics and data for the objects is readily available.

Additionally, performance of non-IT objects (for example people) is measured by extracting data from a proxy IT-system that the non-IT objects use. For example, an enterprise in which people perform a significant portion of the enterprise activity (for example, call center), performance measurements are made by extracting data about people from proxy IT-systems. Example of proxy IT-system may include, employee database, which can be used to extract functions and role of an employee with respect to a business function. Additionally, data that may include, salary, experience and cost to a company can also be extracted to measure the performance of an employee.

After defining one or more performance characteristics of the enterprise, one or more object of the enterprise are identified based on a topology of the enterprise object of the enterprise is one of an infrastructure object and a non-infrastructure object. Examples of the infrastructure objects may include, but are not limited to, server, router, and ATM. Further, examples of the non-infrastructure objects may include, but are not limited to, business process, and people. Before, identifying one or more objects based on a topology of the enterprise, the topology of the enterprise corresponding to one or more dimensions is created. This is further explained in detail in conjunction with FIG. 2.

Thereafter, at step 106, one or more objects of the enterprise are represented on a predefined semantic network. A semantic network is used in knowledge representation and natural language processing areas. The semantic network is a directed graph that includes vertices, which represent objects/concepts and edges, which represent semantic relations between the object/concepts. In various embodiments of the invention, the predefined semantic network is used to model performance of the enterprise by representing one or more objects of the enterprise on the predefined semantic network.

In the predefined semantic network business function of the enterprise can be represented as an enterprise object. The enterprise object is a logical representation of one or more objects of the enterprise. In an embodiment of the invention, an enterprise object has one-to-one correspondence with corresponding physical object. For example, a UNIX server. In another embodiment of the invention, an enterprise object is a complex object that encapsulates a plurality of objects. For example, a patient admission system is defined as a single enterprise object that includes a plurality of objects. The plurality of objects include applications, databases, networks, hardware servers and workflow systems. Further, specialization of an enterprise objects represents an actual object that exists in the enterprise. For example, a specialization of an enterprise object created for an database represents on one or more of Management Information Base (MIB) for the database, important measurement parameters, specific tools and adaptors that are used to monitor the database, benchmarks. Further, the specialization is implemented as code and data structures. Thereafter, the specialization is applied to management of an instance of the Oracle database.

Further, the predefined semantic Network and enterprise objects are decoupled, i.e., the predefined semantic network can be constructed without referring the enterprise objects. Similarly, the enterprise object can be represented by one or more predefined semantic networks based on a perspective that is being used. The decoupling of the predefined semantic network and enterprise objects enables the creation of dynamic views, i.e., enterprise views. The enterprise views include enterprise objects that are linked by semantic relationships. Further, the enterprise views may be treated as enterprise objects. Additionally, measurement functions and management actions are defined for the enterprise views. The enterprise views may be used to create a topology that indicates a way to realize a service in terms of objects of the enterprise. The view indicates the objects and connections of the objects with each other from the perspective of the service. An enterprise view at a lower dimension may be viewed as an object in an enterprise view at a higher dimension.

The enterprise views create a plurality of perspectives of an enterprise object. In an embodiment of the invention, each perspective of the enterprise object is an enterprise object. For example, a database system has data that serves two applications, i.e., employee information and payroll processing. From the perspective of the employee information, the database system includes employee data and the operations that can be performed on the employee data. If the data is erased, then the database system is unavailable from the perspective of employee application irrespective of the state of the database system, engine, and query processor. The enterprise view of the database system from the perspective of the employee information is an enterprise object that the employee application is dependent on. Further, the employee application uses the enterprise view as a resource in operations of the employee application. Additionally, enterprise views are critical for improving the accuracy of measurements and heuristics used for EPM.

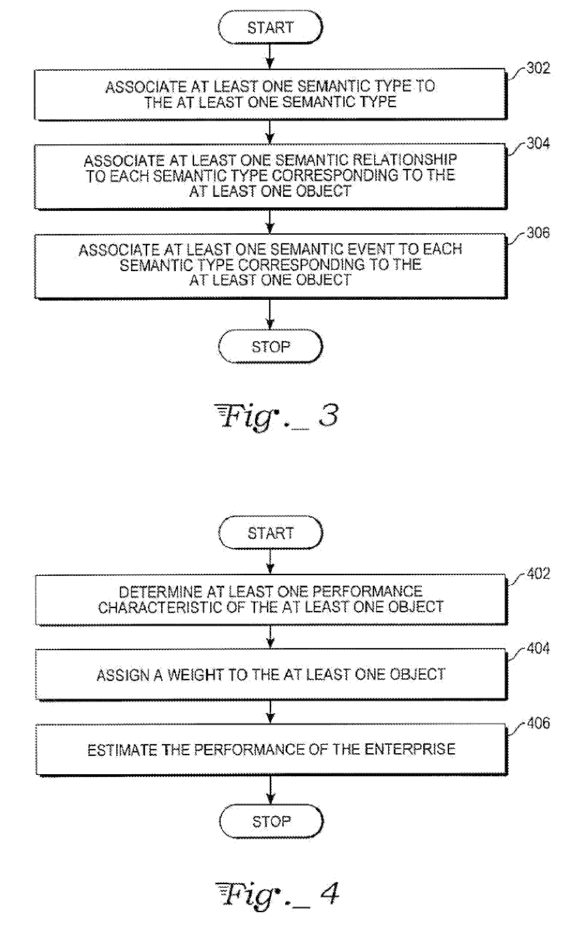

Further, the predefined semantic network includes objects of the enterprise, semantic types, and semantic relationships between objects of the enterprise. The semantic types and the semantic relationships between the objects of the enterprise are used to model the objects of the enterprise. In an exemplary embodiment, the predefined semantic network includes 60 semantic types, and 34 semantic relationships. Further, semantic types and semantic relationships are grouped together to form a plurality of Semantic groups. The plurality of groups are selected based on conditions that include on one or more of, semantic validity, parsimony, completeness, exclusivity, naturalness, and utility. Semantic validity is the coherency of the semantic types and the plurality of groups. Parsimony signifies that the number of groups and semantic types should be as small as possible. Further, completeness is the coverage of a complete domain the plurality of groups. Exclusivity signifies that each object of the enterprise belongs to one or more groups of semantic types. Further, the type of objects that each semantic type inherits and the type of objects that each semantic type does not inherit is defined. Naturalness is the acceptance of the semantic types and the plurality of groups by an expert of the domain. Further, there should be a utility associated with the semantic types and the plurality of groups. This is further explained in detail in conjunction with FIG. 3.

In an embodiment of the invention, the predefined semantic network defines the process of modeling objects from higher dimension, i.e., business system dimension, IT-system dimension, and software system as resource and assets in the infrastructure dimension. There is a semantic distance between objects in higher dimension, and representation of the objects as resources or assets. The predefined semantic network represents series of transformations that are required to transform objects in the higher dimension to resources or assets. Further, the predefined semantic network represents resources and assets in the enterprise and the connection between them for a business function. Additionally, the predefined semantic network represents the workflow for the business function and IT-systems required for executing the business functions and the connections between the IT-systems. The predefined semantic network has the ability to represent evolved resources and assets, new resources and assets added to the enterprise, recently designed business processes, and modified business process without a significant cost of re-implementation. This is further explained in detail in conjunction with FIG. 3.

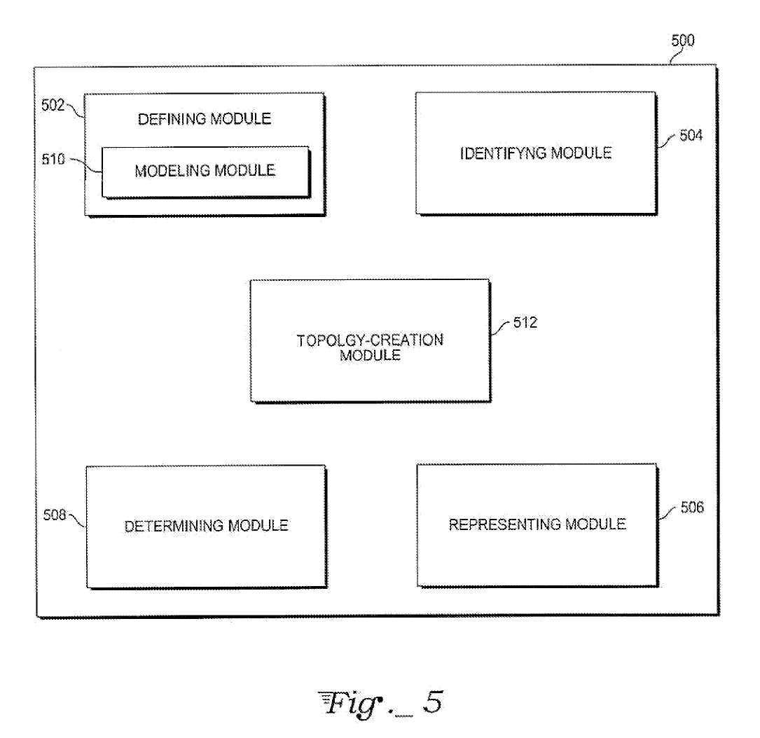

After representing one or more objects of the enterprise on the predefined semantic network, one or more performance characteristics of the enterprise a re determined based on the representation of one or more objects on the predefined semantic network at step 108. This is further explained in conjunction with FIG. 4.

FIG. 2 is a flowchart of a method for managing performance of an enterprise, in accordance with another embodiment of the invention. At step 202, one or more performance characteristics of the enterprise are defined corresponding to one or more dimensions of the enterprise. This has been explained in detail in conjunction with FIG. 1. Thereafter, at step 204 one or more performance characteristics are modeled to measure one or more performance characteristics corresponding to one or more dimensions of the enterprise. This has been explained in detail in conjunction with FIG. 1. Further, at step 206, a topology of the enterprise is created corresponding to one or more dimensions of the enterprise. The topology of the enterprise is created from successive transformation from business system dimension, IT-system dimension, software system dimension, and infrastructure dimension. Therefore, a complete topology of the enterprise is formed from the perspective of a business function.

The topology of the enterprise represents the organization and the structure of objects/systems that are used to execute a business function or a business process. Additionally, a business function may be related to one or more business functions in the enterprise or the business function may include one or more business functions. Therefore, a topology of the enterprise may include a second topology. The second topology acts an object of the topology of the enterprise.

Further, workflows in the business system dimension, IT-system topologies, software applications, and physical infrastructure are modeled in the infrastructure dimension. Therefore, physical aspect of the enterprise is realized in the infrastructure dimension. Additionally, in the complete topology of the enterprise, the characterization of resources and assets in the infrastructure dimension is done according to a dimension of objects that the resources and assets represent. Therefore, relating monitoring data obtained from objects in physical infrastructure using cumbersome methods is not required.

After creating the topology, one or more objects of the enterprise are identified based on the topology of the enterprise corresponding to one or more dimensions, at step 208. An object is one of an infrastructure object and a non-infrastructure object. Further, at step 210, one or more objects are represented on a predefined semantic network. This is further explained in conjunction with FIG. 3. Thereafter, one or more performance characteristics of the enterprise are determined based on the representation of one or more objects on the predefined semantic network, at step 212. This is further explained in detail in conjunction with FIG. 4.

FIG. 3 is a flowchart of a method for representing one or more object of an enterprise on a predefined semantic network, in accordance with an embodiment of the invention. At step 302, one or more semantic types are associated to one or more objects. One or more semantic types are selected from the predefined semantic network. A semantic type is a fundamental quality of property that describes a set of objects of the enterprise. The set of objects may include one or more of physical objects and logical objects. Further, an object inherits one or more semantic types if the object has the characteristics represented by one or more semantic types.

Further, the predefined semantic network includes a plurality of monitoring semantic types, a plurality measurement semantic types, and a plurality of management semantic types. The plurality of semantic types includes errors, exceptions, failure conditions, calculated functions, benchmarks, analytical functions, alerts, thresholds, Mean Time Between Failures (MTBF), Maximum Time To Repair (MTTR), Single Point Of Failure (SPOF), bottleneck, throughput, response time, intensity, peak, load, capacity, utilization, location, cost, state, failure, fault, delay and detect.

An error is the state of a system that may lead to a failure of the system. Further, an exception indicates the violation of a semantic constraint or a define limit being exceeded. If an exception is not managed, it may transform into an error. A failure condition occurs when behavior of an object deviates from its specification. Statistical functions is a set of functions used to calculate statistical parameters that include, but are not limited to, averages, maxima, minima, standard deviations, variances, probability distribution functions. Further, calculated functions have to be calculated using data obtained from monitoring. In an embodiment of the invention, calculated functions are measurement functions. Examples of calculated functions may include, but are not limited to, response time, throughput, and bottleneck functions.

Further, benchmark is a standard, which is used to measure the behavior of an object. The numbers for benchmark for measuring functions that include MTBF and MTTR are provided for engineered objects. If measures (for example, MTBF) for objects are considerably large, then benchmark numbers are required for comparing the objects. For example, MTBF for a mirrored set of disks may be around 100 years. Analytical functions help to analyze the behavior of a system or an object. Additionally, analytical functions are used to analyze data from various perspectives. Further, alerts are events or information that is generated when a threshold is violated. The threshold is a boundary defined for behavior of an object.

In addition to this, MTBF is a statistically derived average number that indicates probability of failure. Further, MTBF does not determine anything by itself. For example, an MTBF of 25 years for a hard disk does not imply that the hard disk will crash or persist after 25 years. Additionally, MTBF may be used to calculate the availability of a system. Further, MTTR is a statistically evaluated value. MTTR captures the maximum time to repair a problem on a failed object and restore the operational state of the object. MTTR may be used to estimate supportability of an object. The availability of a system can be improved by reducing MTTR and increasing MTBF of the system.

Single Point of Failure (SPOF) is a component of a system that does not have a backup. Failure of SPOF causes some degree of downtime. Bottleneck is a choke point within a system. A bottleneck is typically represented by a queue. Bottlenecks in a system leads to delays in the system. Further, throughput is the rate at which work is done. Throughput is measured in terms of number of operations or tasks executed in a time period. Response time is the time taken to complete a unit of work, an operation or a task. Further, an intensity function calculates the magnitude or strength. Intensity functions are used to measure load on an object. Additionally, intensity functions may be used to measure peaks of utilization.

In addition to this, peak value is the highest point or amplitude attained by a variable. Peak value of load is the highest load on an object. Load is the demand for services or operations that a resource can provide. In an embodiment of the invention, load on a resource may be measured as a pattern spread across various operations that the resource can execute. Further, capacity indicates the amount of work a resource can deliver. The amount of capacity of the resource that has been consumed is indicated by utilization. Location is the spatial position of an object within the enterprise. Cost is a set of functions that evaluates one or more of the amount of money, time or resource expended for a specific operation or activity in the enterprise. Further, state is a condition in which an object can exist. In an embodiment of the invention, an object can be in one or more states from a set of possible states. Examples of states may include, but are not limited to, operational, failed, under maintenance, idle, locked.

Failure is a termination of functioning of a system. Additionally, failure is a deviation of a system from specification or service contract of the system. Fault is caused by an error and may lead to a failure. For example, a damaged network cable is a fault that may lead to a network outage. Delay indicates that an operation is taking longer than expected. Additionally, delay is the difference between time taken to complete an operation and expected time to complete the operation. Defect is a flaw in a system. For example, a bug is a defect in a software program.

Further, the plurality of monitoring semantic types include continuous, discrete, transactional, templates, standard, variant, family, group, data source, adaptor, MIB, events, and clusters. Objects that are associated with continuous semantic type never stop. The objects that are associated with continuous semantic type run continuously. Additionally, the objects do not have working hours and are hosts for discrete tasks and activities that represent the work executed by an object. Examples of the objects that are associated with continuous semantic type may include, but are not limited to, hospitals, email servers, backbone routers, and call center operations that run for 24 hours each day.

Additionally, objects that are associated with discrete semantic types, i.e., discrete objects, work in spurts. Examples of the discrete objects may include, but are not limited to, processing of a batch, and an end of day process in a bank. Further, the discrete objects have a start and an end. The discrete objects run to process work for an event. Thereafter, discrete objects may stop running for a short period of time. In an embodiment of the invention, after processing work for the event, the discrete objects may terminate. Further, the discrete objects are measured for the frequency and the duration for which they run. The discrete objects depend on resources for their execution, which results in a spurt of resource utilization when the discrete objects start running.

Further, objects that are associated with transactional semantic type, i.e., transactional objects, have a defined beginning and an end. Examples of the transactional objects may include, but are not limited to, withdrawing money from an ATM, and completing a patient admission operation. The transactional objects are instances of a template. In an embodiment of the invention, measurement and monitoring are defined at the level of the template. Additionally, the transactional objects are not continuous. Further, objects that are associated with template semantic type, i.e., template objects have well defined templates. For example, a business process, which is a template object is compliant with Workflow Management Coalition (WFMC) Interface 4 specification and has a template. Similarly, an end of day process in a bank has a template. Actions and events that are expected from the template objects are defined on the template semantic type. Further, the template objects apply to each instance of template semantic type. In an embodiment of the invention, template semantic type is applied to business systems. In another embodiment of the invention, systems that have transactional semantic type have template semantic type.

Additionally, objects that are associated with standard semantic type, i.e., standard objects, have well defined industry standards. Examples of the standard objects may include, but are not limited to, Basel-2 compliant business processes, and ITIL compliant business process. Further, implementations of the standard objects are clearly defined. Additionally, application of methods used to monitor and measure the standard objects is clearly defined. Standard semantic types have strong tool support, which can be used be used as data sources to get data for the standard objects. In an embodiment of the invention, definitions for the standard objects are upgraded when the standard for the standard objects is upgraded.

Further, objects that are associated with variant semantic types, i.e., variant objects are variants of other objects that are already known. A parent object and a variant object that is a variant of the parent object, have direct or indirect inheritance relationships. For example, a router is a variant of objects in family of the router. Similarly, each database management system is a variant of a generic database management system. Variant semantic type determines reuse of an object. Additionally, variant semantic type allows a variant object of a parent object to inherit behavioral definitions, and benchmarks defined for the parent object.

Additionally, objects that are associated with family semantic type, i.e., family objects, represent a set of objects that share common attributes or common ancestry. Examples of the family objects may include, but are not limited to, product families. Members of a product family do not differ from each other. In an embodiment of the invention, monitoring and measurement functions, and events can be defined at the level of the product family. Thereafter, the defined monitoring and measurement functions, and events are applied to each object that is a member of the product family. Further, object are associated with group semantic type, i.e., group objects, represent related objects that can be treated as a single unit. For example, a web-farm that is an object that inherits group semantic type, represent set of web servers. In an embodiment of the invention, measurement functions are associated with a set of related objects and not with an object from the set of related objects. IT services and service level agreements, i.e., monitoring functions, are defined for groups. For example, a network Service Level Agreement (SLA) of 99.9% availability is defined for the set of objects that collectively make the “network” and not an object from the set of objects. However, monitoring functions may be associated with an object from the set of related objects.

Further, objects that are associated with data-source semantic type, i.e., data-source objects, collate and provide monitoring data for other objects. Examples of the data-source objects may include, but are not limited to, network management software, and database systems that store transaction records. In an embodiment of the invention, if a data-source object is unreachable, then each object that is served by the data-source object cannot be monitored. This is a critical event from an EPM perspective. Further, objects that are associated with adaptor semantic type, i.e., adaptor objects, connect and execute queries to extract monitoring data from a data source. An adaptor is the point of entry for data into a system. Additionally, the adaptor objects polls and gets data, and listens for emitted events. An adaptor object that is unavailable implies that each data sources served by the adaptor object and each object monitored via the data sources cannot be monitored. The unavailability of an adaptor object is a significant event.

MIB semantic type is a structured repository that defines parameters, which can be queried to determine the behavior of an object that is associated with MIB semantic type, i.e., an MIB object. Examples of the MIB semantic type may include, but are not limited to, an SNMP MIB. The SNMP MIB semantic type is implemented by servers, routers, database systems, and application servers. Further, IT objects that are associated with MIB semantic type have strong tools support. Additionally, MIB objects have simple tool-driven way for defining the objects.

Further, objects that are associated with event semantic type, i.e., event objects, are events that happen within an enterprise. In an embodiment of the invention, the event objects have a start and a finish. The event objects have properties that may be one or more of periodic, scheduled, periodic, i.e., expected at a specific date and time, and continuous. When an event semantic type occurs, a part of resources of the enterprise are consumed. Further, the event objects may have adverse impact on the reliability, availability and performance of an enterprise. Important measurements that apply to an event object include source, frequency, impact and cause of the event object.

Additionally, objects that are associated with cluster semantic type, i.e., cluster objects, are a specific instance of a group created to improve fault tolerance. Further, cluster semantic type is a group that includes a plurality of similar objects. MTTR of cluster semantic type is the time taken for a cluster object, to take over the tasks from a failed cluster object. In an embodiment of the invention, MTTR of cluster semantic type is shorter than that of a cluster object. Similarly, cluster semantic type fails if each cluster object that is associated with cluster semantic type fails simultaneously. Therefore, the probability for cluster semantic type to fail is remote. In addition to this, measurements are done at the level of cluster semantic type.

Further, the plurality of management semantic types include business process, IT systems, infrastructure, software, IT, Non-IT, resource, asset, logical and physical. Business process is a semantic type that indicates an organization and a sequence of activities, people and systems that are brought together to accomplish a business function in accordance with a specification. Additionally, business process indicates a specification or a template. Further, objects that are associated with business process semantic type represent workflows. In an embodiment of the invention, the measurement functions of RASP are defined in terms of the workflows.

Additionally, objects that are associated with IT-system semantic type, i.e., IT-system objects, represent processing of information within an enterprise. IT-system semantic type conveys the notion of specific structure and the notion of systems. IT-system semantic type exhibits a plurality of objects, such that, the plurality of objects are organized and have a defined structure to accomplish one or more purposes. Further, IT-system semantic type exhibits a topology, such that, IT-system objects are not standalone entities. Further, the IT-system-objects are represented in hierarchy.

Infrastructure semantic type exhibits an underlying base or foundation. Objects that are associated with infrastructure semantic type, i.e., infrastructure objects, represent the physical realization of each object of the enterprise that does not inherit infrastructure semantic type. Further, infrastructure semantic type can be engineered to a precise specification. Therefore, infrastructure semantic type is conducive to monitoring and measurement. Additionally, monitorable properties of infrastructure objects are available, for example, as a workflow specification or as MIB. In an embodiment of the invention, infrastructure semantic type involves management, inventories, cost and a defined set of services that are provided in an enterprise.

Software semantic type exhibits dynamism, activity and events of an enterprise. Objects that are associated with software semantic type, i.e., software objects, are built according to defined specifications. Further, the software objects have clearly defined interfaces, which indicate the services and functions provide by the software objects. Further, objects that are associated with IT semantic type, i.e., IT objects are under the ownership and definition of the IT organization of an enterprise. Examples of the IT objects may include, but are not limited to, servers, routers, applications, databases, networks, and backup processes. The IT objects may have a defined MIB. The defined MIB may be used to determine the characteristics and measurements of the IT objects.

Further, objects that are associated with non-IT semantic type, i.e., non-IT objects, are no IT objects. Examples of the non-IT objects may include, but are limited to, people, processes, documents, manual operations, and external events. Additionally, the monitoring and measurement data for a has to come from one of a proxy IT object that realizes the non-IT object, manual data entry, and through custom implementations. Further, objects that are associated with resource semantic type, i.e., resource-objects, are used as part of a secondary operation or process. Resource semantic type exhibits the amount or capacity to provide a service. Further, measurements associated with the resource semantic type are calculated from the performance, demand and capacity of the service, the availability and the reliability of providing the service. Additionally, objects that are associated with asset semantic type, i.e., asset objects, are resources and have cost definitions assigned to them. Further, asset objects are inventoried and managed within an enterprise. For example, the IT-objects may be considered as asset-objects. Similarly, people within an enterprise may be considered as asset-objects. Each object of the enterprise is associated with one of resource semantic type or asset semantic type in the infrastructure dimension of the enterprise.

Additionally, objects that are associated with logical/virtual semantic type, i.e., logical objects, do not have a physical existence. Example of the logical objects may include, but is not limited to, business process. Further, the logical objects are simulated and leave traces of their presence. However, the logical objects cannot be perceived directly. Therefore, physical objects are used as sources for monitoring data for the logical objects. Further, objects that are associated with physical semantic type, i.e., physical objects, have a tangible physical existence. Examples of the physical objects may include, but are not limited to, servers, routers, a running application executable, and a specific instance of a database. Further, the physical objects can be directly monitored. Additionally, monitoring data for the physical objects can be obtained from defined data sources where monitoring data can be obtained for the physical objects.

After associating one or more semantic types with one or more objects, one or more semantic relationships are associated to each semantic type corresponding to one or more objects, at step 304. One or more semantic relationships are selected from the predefined semantic network. A semantic relationship captures an essential quality of the interaction and relationship between semantic types. Examples of semantic relations may include, but are not limited to, dependency, single point of failure, usage, hosting, containment, membership, aggregation, grouping, and realization. Additionally, semantic relationships capture associative nature of the relationship between semantic types. For example, if a web application is hosted-by a Unix server, the availability of the web application is directly impacted by the availability of the Unix server. However, if the web application is hosted-by a set of Unix servers that have a clustered relationship with each other, then the availability of a Unix server does not affect the availability of the web application. In this example, hosted-by and clustered are relationships that capture how the RASP of objects, i.e., web application and Unix servers are impacted by interactions between them.

Additionally, semantic relationships between semantic types determine the method to evaluate RASP of an object. Additionally, the semantic relationships exhibit how the RASP of an object is impacted. For example, an is-realized-by semantic relationship applies between logical semantic types and physical semantic type. In this case, the is-realized-by semantic relationship depicts that the logical objects (for example, business process) require the physical objects (for example, workflow system) to provide environment in which the existence of the logical objects can be realized. Further, the is-realized-by semantic relationship exhibits that is the physical objects are not available, then the logical objects will not be available.

Further, the predefined semantic network includes a plurality of temporal semantic relationships, a plurality of spatial semantic relationships, a plurality of physical semantic relationships, a plurality of conceptual semantic relationships, a plurality of function semantic relationships, and a plurality of base semantic relationships. The pluralities of temporal semantic relationships represent interactions and relationships that are dependent on time. Further, the plurality of spatial semantic relationships represent the spatial dependencies. The plurality of physical semantic relationships are used as relationships between objects of the enterprise. Additionally, the plurality of conceptual semantic relationships represent relationships that are conceptual in nature. For example, relationships such as part-of, measures, contributes to etc. The plurality of functional semantic relationships represent the functional relations. Examples of the functional relations may include, but are not limited to, uses, polls, and causes. The plurality of base semantic relationships represent relations of type parent-child relationships.

Further, one or more semantic relationships include member-of, backup-to, runs-on, co-occurrence, measures, uses, occurs-in, contributes, in-serial-with, in-cluster, precedes, located-with, aggregates, consumes, polls, causes-error, part-of, in-parallel-with, contains, follows, surrounds, is-SPOF-to, depends-on, listens, belongs-to, realizes, hosts, wait-for, adjacent-to, is-bottleneck-to, indicates and causes. In member-of semantic relationship, a source of a relationship belongs to a group or an organization indicated by a target of the relationship. Additionally, in backup-to semantic relationship, a source of a relationship performs the operations of a target of the relationship, if the target is not in an operation state. Further, in runs-on semantic relationship, a target of a relationship provides a source of the relationship an environment to operate in. In co-occurrence semantic relationship, a source and a target of a relationship occur simultaneously. Further, in measures semantic relationship, a source of a relationship evaluates the dimension or the extent/degree of a target of the relationship.

In addition to semantic relationships given above, in uses semantic relationship, a source of a relationship employs the services of a target of the relationship. Further, in occurs-in semantic relationship, a source of a relationship appears within a target of the relationship. In an embodiment of the invention, the target is a set and the source is a member of the set. In contributes semantic relationship, a target of a relationship is the result a source of the relationship, i.e., the source is the cause of the target. For example, in a relation an unhandled exception leads to an error. Further, in in-serial-with semantic relationship, a source and a target of a relationship have a serial arrangement, i.e., the source follows the target or the target follows the source. In in-cluster semantic relationship, a source and a target of a relationship are organized in a group for fault tolerance.

Further, in precedes semantic relationship, a source of a relationship occurs before occurrence of a target of the relationship. The source cannot occur after the target. Additionally, precedes semantic relationship is used to identify a sequence of tasks or steps. In located-with semantic relationship, a source of a relationship shares a spatial coordinate with a target of the relationship. Further, in aggregates semantic relationship, a source of a relationship is an aggregation of a target of the relationship. The measurements of the source are made by aggregating corresponding measurements of the target. Additionally, in consumes semantic relationship, operations of a source of a relationship include services provided by a target of the relationship. In polls semantic relationship, a source of a relationship periodically executes an operation or a query on a target of the relationship. Further, in causes-error semantic relationship, a source of a relationship induces a state in a target of the relationship that may lead to a failure of the target. In part-of semantic relationship, a source of a relationship is an element or a piece of a target of the relationship.

Additionally, in in-parallel-with semantic relationship, a source and a target of a relationship can operate simultaneously. In-parallel-with semantic relationship indicates that an operation can be divided across the source and the target or the source and the target execute different operations simultaneously. Further, in contains semantic relationship, a source of a relationship includes a target of the relationship physically. In an embodiment of the invention, in contains semantic relationship, the target may be measured individually. However, if the source is not available, then the target will not be available. Additionally, in follows semantic relationship, a source of a relationship occurs after a target of the relationship has occurred. Further, in surrounds semantic relationship, a source of a relationship surround a target of the relationship. Surrounds semantic relationship is a spatial relationship. In is-SPOF-to semantic relationship, a source of a relationship is a single point of failure to a target of the relationship. If the source in is-SPOF-to semantic relationship fails, then the target also fails. Further, in depends-on semantic relationship, a source of a relationship depends on services provided by a target of the relationship. For example, a defect, delay, fault or failure in the target impacts the source. In listens semantic relationship, a source of a relationship point to a predefined location to receive one or more of messages and events from the target.

Further, in belongs-to semantic relationship, a source of a relationship is part of a group, which is defined by a target of the relationship. In realizes semantic relationship, a target of a relationship is a virtual entity. The physical manifestation of the target is provided by a source of the relationship. Additionally, in costs semantic relationship, a target of a relationship uses a source of the relationship for execution, such that, if the source is unavailable, then the target is also not available. In addition to this, the target consumes resources provided by the source. Further, in waits-for semantic relationship, a source of a relationship waits for a target of the relationship to complete an operation. In adjacent-to semantic relationship, a source of a relationship is physically adjacent to a target of the relationship. Additionally, in is-bottleneck-to, a source of a relationship is a choke point for a target of the relationship, such that, the source causes delays in the target. In indicates semantic relationship, behavior of a source of a relationship signal an impact on a target of the relationship. For example, a delay in a resource indicates a delay in the consumer of the resource. In causes semantic relationship, behavior of a source of a relationship produces an effect on a target of the relationship.

After associating one or more semantic relationships to each semantic type, one or more semantic events are associated to each semantic type corresponding to one or more objects, at step 306. One or more semantic events are selected from the predefined semantic network. A semantic event impacts RASP of the enterprise based on one or more of nature of the semantic event, source from which the semantic event emanates, and relationship between objects of the enterprise. Therefore, attributes of a semantic event are described in terms of RASP semantics of the semantic event. In an embodiment of the invention, one or more semantic events are categorized in terms of RASP semantics of one or more semantic events over the categorization of objects of the enterprise. Thereafter, the categorization is analyzed with one or more semantic relationships between objects of the enterprise and semantic relationships between one or more semantic types to determine the impact and cause of on or more semantic events. For example, considering continuous semantic type. Objects that inherit continuous i run continuously. The continuous objects are critical to the operation of the enterprise. An event that indicates that status is down is emitted for a continuous object may lead to a serious error in the operation of the enterprise with all discrete objects hosted by this object no longer available. Additionally, the availability of the continuous object in itself is impacted because of the event that indicates that status is down.

Thereafter, semantic events that have an impact on RASP of the enterprise are filtered. Further, a semantic event, which has a defined source, i.e., an object, is analyzed to determine if the semantic event has an impact on RASP of the source. Thereafter, cause of the semantic event is inferred and impact of the semantic event on objects of the enterprise is determined.

Further, the predefined semantic network includes a plurality of symptoms semantic events, a plurality of diagnosis semantic events and a plurality of prognosis semantic events. The plurality of symptoms semantic events indicate abnormal behavior in the enterprise. Further, the plurality of diagnosis semantic events identify the nature and/or cause of an observed phenomenon. The plurality of prognosis semantic events are a prediction of a possible course and an outcome of a phenomenon.

Additionally, one or more semantic events include, incident, input, informative, internal, external, errors, exceptions, monitoring-queries, local, repetitive, priority, frequent, rare, failure, fault, warnings, throughput, response-time, bottlenecks, recurring, sporadic, delay, defect, statistical-data, alarms, time-to-live, pain-point, severity and will-propagate. Include semantic event is an uncharacteristic event that is considered as serious. Further, include semantic event has a significant impact. In an embodiment of the invention, include semantic event is not frequent and is difficult to predict in advance. Input semantic event is externally added into a system through manual data entry. Additionally, input semantic event is information that is not obtained through monitoring. However, input semantic event signifies a change to an environmental condition that is not monitored. For example, information of a severe storm that can disrupt business is input semantic event.

Further, informative semantic event is monitoring data that is periodically gathered from objects. Internal semantic event is an event, a cause of which is within the control of the enterprise. the enterprise is responsible for internal semantic event and an impact of internal semantic event. Additionally, external semantic event is an external event that cannot be controlled by the enterprise. If external semantic event causes a drop in service quality of a business function, then the drop in service quality can be negotiated with a customer using the business function and relief for the drop can be implemented. Examples of external semantic event may include, but are not limited to, major power outages, and external vendor failures. Further, errors semantic event indicates that a system is in a state, which may lead to a failure of the system. The system or an environment of the system may be in an inconsistent state to cause the failure. Additionally, the system may have performed an incorrect operation to cause the failure. Exception semantic event indicates that a boundary or a limit has been violated.

Additionally, monitoring-queries semantic event pertains to regular monitoring and querying of data sources. Local semantic event is an event, RASP impact of which is confined to an object that caused local semantic event. Further, propagative semantic event creates a ripple impact on RASP of objects that are semantically related to a source of propagative semantic event. Repetitive semantic event needs multiple samples before their evaluation. In an embodiment of the invention, repetitive semantic event is gathered in a time window and then executed or processed in a batch. Additionally, repetitive semantic event indicates duplicate events. For example, if an element of a network in a system fails, then the system can get events that are unreachable from monitoring points of each device on the network. The system does not need to process each event individually.

Further, priority semantic events carry a priority indicator. For example, messages emitted by software systems may exhibit priority, which indicates the severity of the messages. Frequent semantic events occur very often. Additionally, rare semantic event is unpredictable and does not occur very often. In an embodiment of the invention, rare semantic event can be a serious incident. Failure semantic event indicates a failure of an object. Further, fault semantic event indicates a fault that has occurred within an object. Warning semantic event carry warning messages. Further, warning semantic event is important from a perspective of predictive analysis. For example, disk systems start emitting warning semantic events when the disk systems reach a critical level of utilization. The warning semantic events include information that can be used to analyze the impact of a failed disk before the disk hits saturation. The analysis of the information is used avoid significant breakdowns in the system.

Additionally, throughput semantic event indicate one or more of peaks and troughs of a throughput. In an embodiment of the invention, throughput semantic event indicate that a throughput has been recalculated. Response-time semantic event indicates one or more of peaks and troughs in response times. In an embodiment of the invention, response-time semantic event indicates that response times have been recalculated. Further, bottleneck semantic event indicate that an object has become a bottleneck. Additionally, bottleneck semantic event is generated when a system observes that queues are building up for a resource. Recurring semantic event occurs periodically. Additionally, recurring semantic event has a pattern of occurrence. In an embodiment of the invention, the nonoccurrence of recurring semantic event may be a cause for concern. Examples of recurring semantic event include, but are not limited to, events that indicate the start and completion of periodic maintenance, and events that indicate start and completion of a discrete, scheduled batch-job.

Further, sporadic semantic event occurs at random intervals of time. Sporadic semantic event has to be processed individually and is difficult to predict. Additionally, patterns cannot be build around sporadic semantic event. Delay semantic event indicates that a delay has occurred or will occur in an operation of an object. Additionally, defect semantic event indicates that a defect has occurred or will occur in an operation of an object. Statistical-data semantic event indicates that statistical data for an object needs to be recomputed. Further, alarm semantic event indicates that a threshold has been violated and a user alarm has been triggered. Further, time-to-live semantic event indicates the time before an SLA of an object is violated due to the impact of an event on the object. Pain-point semantic event is an event for which a solution cannot be found. Therefore, point-point event has to be ignored. Further, severity semantic event is a prognosis that indicates the severity of an impact created by an event. Additionally, will-propagate semantic event is a prognosis that indicates that an impact of an event that will propagate across objects in the enterprise.

Therefore, as explained in the steps above, one or more performance characteristic of the enterprise are determined base on one or more semantic types, one or more semantic relationships, and one or more semantic events corresponding to one or more objects of the enterprise. This is further explained in detail in conjunction with FIG. 4.

FIG. 4 is a flowchart of a method for determining one or more performance characteristics of the enterprise, in accordance with an embodiment of the invention. At step 402, one or more performance characteristics of one or more objects are determined based on the corresponding one or more semantic types, one or more semantic relationships, and one or more semantic types. One or more performance characteristics of one or more objects are determined based on their association with one or more semantic types, one or more semantic relationships, and one or more semantic types, which has been explained in conjunction with FIG. 3. In an embodiment of the invention, before determining performance characteristic of one or more object, each of reliability, availability, performance, and supportability of one or more objects is assigned a weight.

Thereafter, at step 404, a weight is assigned to each object in the enterprise. The weight is assigned to an object corresponding to position of the object in hierarchy of the enterprise. Further, at step 406, the performance of the enterprise is determined based on the determined performance of the one or more objects and the weight corresponding to one or more objects.

FIG. 5 is a block diagram of a system 500 for managing performance of the enterprise, in accordance with an embodiment of the invention. System 500 includes a defining module 502, an identifying module 504, a representing module 506, and a determining module 508. Defining module 502 defines one or more performance characteristics of the enterprise corresponding to one or more dimensions of the enterprise. One or more performance characteristics include, reliability, availability, performance, and supportability. This has been explained in detail in conjunction with FIG. 1. Further, one or more dimensions include business system dimension, an IT-system (dimension, a software system dimension and infrastructure dimension. This has been explained in conjunction with FIG. 1. Additionally, defining module 502 includes a modeling module 520. Modeling module 510 models one or more performance characteristics to measure one or more performance characteristics corresponding to one or more dimensions of the enterprise. The method of modeling has been explained in conjunction with FIG. 1.

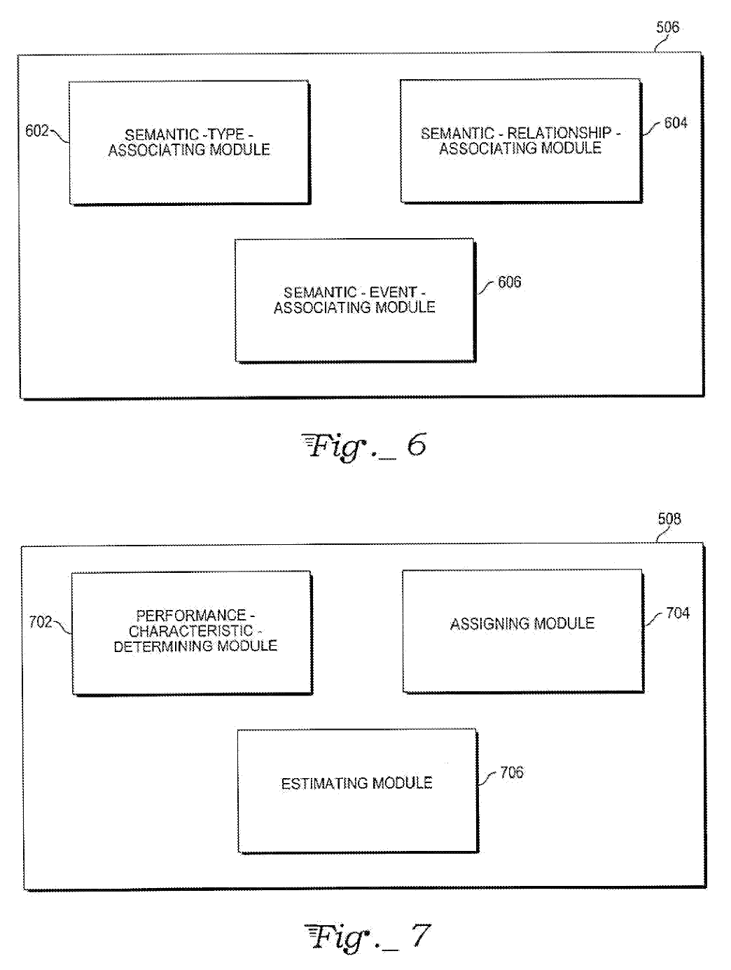

Further, identifying module 504 identifies one or more objects of the enterprise based on a topology of the enterprise corresponding to one or more dimensions. An object of the enterprise is one of an infrastructure object and a non-infrastructure object. The method for identifying one or more objects has been explained in conjunction with FIG. 2. In an embodiment of the invention, system 500 includes a topology-creation module 512. Topology-creation module 512 creates the topology of the enterprise corresponding to one or more dimensions. This has been explained in detail in conjunction with FIG. 2. Thereafter, representing module 506 represents one or more objects of the enterprise on a predefined network. A semantic network is used in knowledge representation and natural language processing areas. The semantic network is a directed graph that includes vertices, which represent objects/concepts and edges, which represent semantic relations between the object/concepts. Representing module 506 is explained in detail in conjunction with FIG. 6.

After representing one or more objects on the predefined semantic network, determining module 508 determines one or more performance characteristics of the enterprise based on the representation of one or more objects on the predefined semantic network. Determining module 508 is explained in detail in conjunction with FIG. 6.

FIG. 6 is a block diagram showing components of representing module 506, in accordance with an embodiment of the invention. Representing module 506 includes a semantic-type-associating module 602, a semantic-relationship-associating module 604, and a semantic-event-associating module 606. Semantic-type-associating module 602 associates one or more semantic types to one or more objects. One or more semantic types are selected from the predefined semantic network. A semantic type is a fundamental quality or property that describes a set of objects of the enterprise. The set of objects may include one or more of physical objects and logical objects. Further, an object inherits one or more semantic types if the object has the characteristics represented by one or more semantic types. This has been explained in conjunction with FIG. 3.

Thereafter, one or more semantic relationships are associated to each semantic type corresponding to one or more objects by semantic-relationship-associating module 604. One or more semantic relationships are selected from the predefined semantic network. A semantic relationship captures an essential quality of the interaction and relationship between semantic types. Additionally, semantic relationships capture associative nature of the relationship between semantic types. This has been explained in conjunction with FIG. 3. Further, semantic-event-associating module 606 associates one or more semantic events to each semantic type corresponding to one or more objects. One or more semantic events are selected from the predefined semantic network. This has been explained in conjunction with FIG. 3. A semantic event impacts RASP of the enterprise based on one or more of nature of the semantic event, source from which the semantic event emanates, and relationship between objects of the enterprise. Therefore, attributes of a semantic event are described in terms of RASP semantics of the semantic event.

FIG. 7 is a block diagram showing various components of determining module 508, in accordance with an embodiment of the invention. Determining module 508 includes a performance-characteristic-determining module 702, an assigning module 704, and an estimating module 706. Further, performance-characteristic-determining module 702 determines one or more performance characteristics of one or more objects based on the corresponding one or more semantic types, one or more semantic relationships, and one or more semantic events. This has been explained in detail in conjunction with FIG. 4. Thereafter, a weight is assigned to one more objects by assigning module 704. This has been explained in detail in conjunction with FIG. 4. Further, estimating module 706 estimates the performance characteristics of the enterprise based on the determined performance of one or more objects and the weight corresponding to one or more objects. This has been explained in detail in conjunction with FIG. 4.

Further, a computer program product used with a computer includes a computer usable medium. The computer usable medium has a computer readable program code embodied therein for managing performance of the enterprise. Further, the computer readable program code defines one or more performance characteristics of the enterprise corresponding to one or more dimensions of the enterprise. Additionally, the computer readable program code identifies one or more objects of the enterprise based on a topology of the enterprise. One or more objects are identified corresponding to the one or more dimensions. Further, an object is one of an infrastructure object and a non-infrastructure object. Thereafter, the computer readable program code represents one or more objects of the enterprise on a predefined semantic network. Further, the computer readable program code determines one or more performance characteristic of the enterprise based on the representation of the one or more objects on the predefined semantic network.

Various embodiments of the invention provide methods and systems that considerably reduces the time and cost of implementing a powerful, scalable, and flexible EPM solution an enterprise. Additionally, a conceptual structure of the enterprise can be modeled. The conceptual structure is used to define EPM for the enterprise. Further, EPM can be modeled for multi-function, multi-process, multi-structured modern enterprises. Additionally, EPM solution for the enterprise can be easily expanded if the enterprise evolves. This is possible because of the flexibility and adaptability of a semantic network. Further, each object in the enterprise and performance characteristics of each object is represented in terms of RASP. Additionally, due to specification and transformation of higher order objects, cumbersome and ad-hoc correlations are eliminated. Examples of the higher order objects may include, but are not limited to, business functions, processes, and systems. Further, an object can be represented as a resource or an asset, due to powerful and innovative semantic transformations. Therefore, determination of EPM of the enterprise becomes straightforward and simple.

Further, the various embodiments of the invention provide methods and systems provide a deterministic and predictable model of measuring performance of the enterprise. Further, as the overall performance of the enterprise is defined consistently as a function of RASP, therefore, the need for custom implementations is eliminated. Additionally, non-infrastructure resources, for example, people and processes are integrated. Further, as dynamic views and topologies of the enterprise can be generated from perspective of business functions, therefore organization, process, and structure of the enterprise can be represented from perspective of the business functions. Additionally, reporting systems can be built as a set of features based on performance of the business functions. Examples of the reporting systems may include, but are not limited to, capacity planning, resource planning, and business scorecards. The set of features can be integrated without making a fundamental change.

Additionally, because of the representation of semantic types, an d semantic models, reengineering efforts to adapt with evolving enterprise are not required. Further, a dynamic event model provides real time information, and measurements about critical events, activity and effect of the events on the performance and efficiency of the enterprise. Additionally, new semantic types, new relationships, and new types of events can be added flexibly through a programming interface. The programming interface ensures longevity of the invention. Further, additional semantic types covering specific domains, for example, healthcare, financial services, retail, and services can be added. Therefore, EPM models are more accurate for particular vertical segments.

What is claimed is:

1. A method for managing performance of an enterprise, the method comprising:
a. defining at least one performance characteristic of the enterprise corresponding to at least one dimension of the enterprise;
identifying at least one object of the enterprise based on a topology of the enterprise corresponding to the at least one dimension, wherein an object is one of an infrastructure object and a non-infrastructure object;
c. representing the at least one object of the enterprise on a predefined semantic network; and
determining at least one performance characteristic of the enterprise based on the representation of the at least one object on the predefined semantic network.

2. The method of claim 1, wherein the step of defining comprises modeling the at least one performance characteristic to measure the at least one performance characteristic corresponding to the at least one dimension.

3. The method of claim 1 further comprising the step of creating the topology of the enterprise corresponding to the at least one dimension.

4. The method of claim 3, wherein the topology is created from successive transformation from business system dimension, IT-system (Information Technology System) dimension, software system dimension and infrastructure dimension.

5. The method of claim 1, wherein the step of representing comprises:
a. associating at least one semantic type to the at least one object, wherein the at least one semantic type is selected from the predefined semantic network;
b. associating at least one semantic relationship to each semantic type corresponding to the at least one object, wherein the at least one semantic relationship is selected from the predefined semantic network; and
c. associating at least one semantic event to each semantic type corresponding to the at least one object, wherein the at least one semantic network.

6. The method of claim 5, wherein the at least one performance characteristic of the enterprise is determined based on the at least one semantic type, the at least one semantic relationship, and the at one modeled semantic event corresponding to the at least one object.

7. The method of claim 1, wherein a performance characteristic is one of a reliability, availability, supportability and performance.

8. The method of claim 1, wherein a dimension of the enterprise is one of business system dimension, an IT-system (Information Technology System) dimension, a software system dimension and infrastructure dimension.

9. The method of claim 5, wherein the predefined semantic network comprises a plurality of measurement semantic types, a plurality of monitoring semantic types and a plurality of management semantic types.

10. The method of claim 9, wherein the plurality of measurement semantic types comprise errors, exceptions, failure conditions, calculated functions, benchmarks, analytical functions, alerts, thresholds, MTBF (Mean Time Between Failures), MTTR (Maximum Time To Repair), SPOF (Single Point Of Failure), bottleneck, throughput, response time, intensity, peak, load, capacity, utilization, location, cost, state, failure, fault, delay and detect.

11. The method of claim 9, wherein the plurality of monitoring semantic types comprise continuous, discrete, transactional, template, standard, variant, family, group, data source, adaptor, Management Information Base (MIB), events, and clusters.

12. The method of claim 9, wherein the plurality of management semantic types comprise business process, IT (Information Technology) systems, infrastructure, software, IT, Non-IT, resource, asset, logical and physical.

13. The method of 12, wherein each object of the enterprise is associated with one or the resource and asset, when the dimension of the enterprise is an infrastructure dimension.

14. The method of claim 5, wherein the predefined semantic network comprises a plurality of temporal relationships, a plurality of physical semantic relationships, a plurality of conceptual semantic relationships, a plurality of functional semantic relationships and a plurality of base semantic relationships.

15. The method of claim 5, wherein the at least one semantic relationship comprises member-of, backup-to, runs-on, co-occurrence, measures, uses, occurs-in, contributes, in-serial-with, in-cluster, precedes, located-with, aggregates, consumes, polls, causes-error, part-of, in-parallel-with, contains, follows, surrounds, is-SPOF-to, depends-on, listens, belongs-to, realizes, hosts, wait-for, adjacent-to, is-bottleneck-to, indicates and causes.

16. The method of claim 5, wherein the predefined semantic network comprises a plurality of symptoms semantic events, a plurality of diagnosis semantic events and a plurality of prognosis semantic events.

17. The method of claim 5, wherein the at least one semantic event comprises incident, input, informative, internal, external, errors, exceptions, monitoring-queries, local, propagative repetitive, priority, frequent, rare, failure, fault, warnings, throughput, response time, bottlenecks, recurring, sporadic, delay, defect, statistical-data, alarms, time-to-live, pain-point, severity and will-propagate.

18. The method of claim 1, wherein the step of determining comprises:
a. determining at least one performance characteristic of the at least one object based on the corresponding at least one semantic type, at least one semantic relationship, and at least one semantic event;
b. assigning a weight to the at least one object; and
c. estimating the performance of the enterprise based on the determined performance of the at least one object and the weight corresponding to the at least one object.

19. The method of claim 1, wherein a business function of an enterprise can be represented as an enterprise object, wherein the enterprise object is a logical representation of at least one object of the enterprise.

20. A system for managing performance of an enterprise, the system comprising:
a. a defining module for defining at least one performance characteristic of the enterprise corresponding to at least one dimension of the enterprise;
b. an identifying module for identifying at least one object of the enterprise based on a topology of the enterprise corresponding to the at least one dimension, wherein an object is one of an infrastructure object and a non-infrastructure object;
c. a representing module for representing the at least one object of the enterprise on a predefined semantic network; and
d. a determining module for determining at least one performance characteristic of the enterprise based on the representation of the at least one object on the predefined semantic network.

21. The system of claim 20, wherein the defining module comprises a modeling module for modeling the at least one performance characteristic to measure the at least one performance characteristic corresponding to the at least one dimension.

22. The system of claim 20 further comprising a topology-creating module for creating the topology of the enterprise corresponding to the at least one dimension.

23. The system of claim 20, wherein the representing module comprises:
a. an semantic-type-associating module for associating at least one semantic type to the at least one object, wherein the at least one semantic type is selected from the predefined semantic network;
b. an semantic-relationship-associating module for associating at least one semantic relationship to each semantic type corresponding to the at least one object, wherein the at least one semantic relationship is selected from the predefined semantic network; and
c. an semantic-event-associating module for associating at least one semantic event to each semantic type corresponding to the at least one object, wherein the at least one semantic event is selected from the predefined semantic network.

24. The system of claim 20, wherein the determining module comprises:
a. a performance-characteristic-determining module for determining at least one performance characteristic of the at least one object based on the corresponding at least one semantic type, at least one semantic relationship, and at least one semantic event;
b. an assigning module for assigning a weight to the at least one object; and
c. an estimating module for estimating the performance of the enterprise based on the determined performance of the at least one object and the weight corresponding to the at least one object.

25. A computer program product for use with a computer, the computer program product comprising a computer usable medium having a computer readable program code embodied therein for managing performance of an enterprise, the computer readable program code performing:
a. defining at least one performance characteristic of the enterprise corresponding to at least one dimension of the enterprise;
b. identifying at least one object of the enterprise based on a topology of the enterprise corresponding to the at least one dimension, wherein an object is one of an infrastructure object and a non-infrastructure object;
c. representing the at least one object of the enterprise on a predefined semantic network; and
d. determining at least one performance characteristic of the enterprise based on the representation of the at least one object on the predefined semantic network.
